(19) United States
(12) Patent Application Publication
(10) Pub. No.: US 2015/0312393 A1
(43) Pub. Date: Oct. 29, 2015

(54) VOICE COMMUNICATION METHOD AND ELECTRONIC DEVICE USING THE SAME

(71) Applicant: Wistron Corporation, New Taipei City (TW)

(72) Inventor: Chieh-Wen Chen, New Taipei City (TW)

(21) Appl. No.: 14/499,277

(22) Filed: Sep. 29, 2014

(30) Foreign Application Priority Data
Apr. 25, 2014 (TW) 103115094

(51) Int. Cl. H04M 1/64; H04M 1/02

(52) U.S. Cl. CPC H04M 1/64; H04M 1/0202

(57) ABSTRACT

A voice communication method for an electronic device includes receiving a phone call; detecting whether a user performs an answering action when receiving the phone call; and activating a voice communication of the phone call when detecting that the user performs the answering action; wherein the answering action does not include an action of triggering a button on the electronic device.

### BACKGROUND OF THE INVENTION

1. Field of the Invention

The present invention relates to a voice communication method and related electronic device, and more particularly, to a method of answering a phone call for voice communication and an electronic device using said method.

2. Description of the Prior Art

While significant progress in technology has increased the convenience of people's day to day lives, it has also caused people to rely on technology to a greater degree than ever before. For example, computer processors have undergone huge developments in recent years, such that the time taken for a computer to execute tasks has become shorter and shorter. In the past, opening a web browser could take 5-10 seconds, but for most modern users, the same task should take less than 1 second. Recent studies have found that people notice the addition of an extra 4 milliseconds (i.e. the time it takes to blink). If computer processing speeds continue to develop at the same rate, shaving off as little as a millisecond may become a vital selling point.

Common communication software, such as Line and WeChat, is equipped with shaking functionality for making friends. Many communication devices also include built-in voice input functionalities so the user does not waste time on searching for and keying in words. Although most communication devices are equipped with user facilitated input functionalities, the most frequently used voice communication functionality of a smart phone still requires the user to press a physical button or a confirmation button on a touch screen in order to receive a phone call, which adds to the time required to complete a task. Thus, there is a need for improvement over the prior art.

### SUMMARY OF THE INVENTION

It is therefore an objective of the present invention to provide a method of answering a phone call and an electronic device using the same, which are capable of directly utilizing a natural action of answering a telephone to activate a voice communication, in order to enhance convenience and prevent wasted time.

The present invention discloses a voice communication method for an electronic device. The voice communication method comprises receiving a phone call; detecting whether a user performs an answering action when receiving the phone call; and activating a voice communication of the phone call when detecting that the user performs the answering action; wherein the answering action does not comprise an action of triggering a button on the electronic device.

The present invention further discloses an electronic device, comprising: a voice communication module, for receiving a phone call; and an action detection module, for detecting whether a user performs an answering action when the voice communication module receives the phone call; wherein the voice communication module activates a voice communication of the phone call when the action detection module detects that the user performs the answering action; and wherein the answering action does not comprise an action of triggering a button on the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to an embodiment of the present invention.

FIG. 2 is a schematic diagram of a gyroscope detecting motion of the electronic device in different directions.

FIG. 3 is a waveform diagram generated by the gyroscope.

FIG. 4 is a schematic diagram of a smart watch according to an embodiment of the present invention.

FIG. 5 is a schematic diagram of a phone call answering process according to an embodiment of the present invention.

FIG. 6 is a schematic diagram of another phone call answering process according to an embodiment of the present invention.

### DETAILED DESCRIPTION

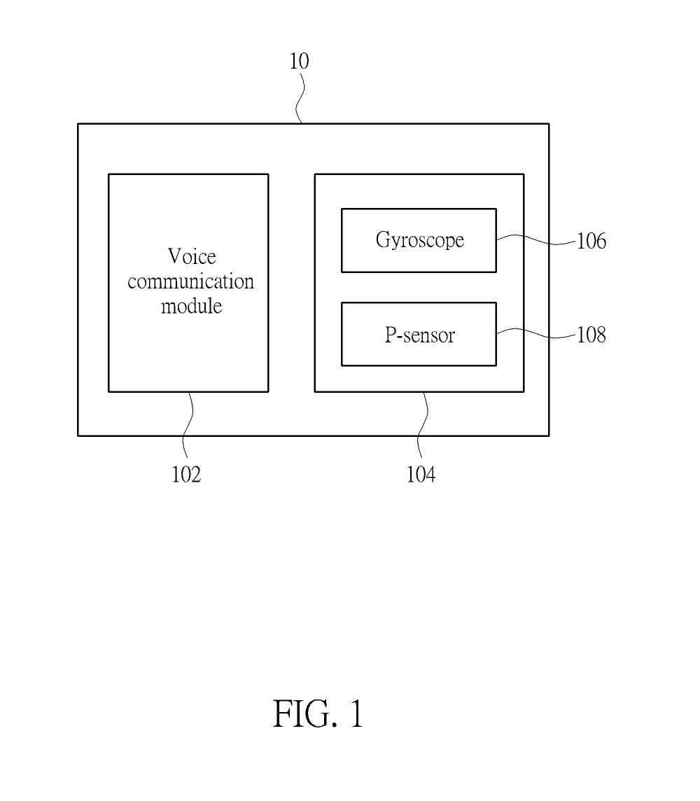

Please refer to FIG. 1, which is a schematic diagram of an electronic device 10 according to an embodiment of the present invention. The electronic device 10 includes a voice communication module 102 and an action detection module 104. The voice communication module 102 is utilized for receiving a phone call and performing various voice communication functions of the electronic device 10, such as activating a voice communication, terminating a voice communication and switching a voice communication. The action detection module 104 is utilized for detecting an action of the user. When the voice communication module 102 receives a phone call, the action detection module 104 may detect whether the user performs an answering action. When the answering action is detected, the voice communication module 102 may activate a voice communication. The action detection module 104 may include a gyroscope 106 and a proximity sensor (P-sensor) 108.

In detail, the electronic device 10 may be a smart phone or any device having voice communication functionalities. The voice communication module 102 is utilized for processing the voice communication functions in the electronic device 10, and the action detection module 104 is utilized for detecting the action of the user. When the user uses a mobile phone to perform voice communication, the user may answer a phone call via an answering action, which may include a turning action and an approaching action. The turning action is an action of turning the electronic device 10. If the electronic device 10 is a mobile phone, the user needs to turn the front of the mobile phone to the left side of the user if the user needs to hear using their right ear, or turn the front of the mobile phone to the right side of the user if the user needs to hear using their left ear. The approaching action is an action of the user taking the electronic device 10 to approach their ears, and is used when the electronic device 10 is a mobile phone that does not have a loudspeaker or Bluetooth earphones, as the user needs to approach the mobile phone to their ears when talking.

Please note that the answering action of the present invention only includes the action of picking up a telephone to talk, i.e. picking up a mouthpiece of a traditional telephone and putting it near a user's ears. The answering action may not include any actions other than picking up the telephone, such as the action of triggering any buttons on the electronic device 10. In other words, when a user answers a phone call, the user may not need to press or click any buttons on the electronic device 10; the user may only need to pick up the electronic device 10 or the voice communication device thereof and approach their ears in order to start the voice communication. In addition, other actions predetermined for triggering the electronic device 10 to answer a phone call such as voice control and eyeball control should not be included in the answering action of the present invention. Voice control would comprise the user speaking a specific word/sentence for answering the phone call, and eyeball control would comprise the user aiming an eyeball at a specific detector for answering the phone call, which are both atypical actions when answering a telephone call. In comparison, the answering actions according to the present invention only include customary answering actions utilized for answering a traditional telephone.

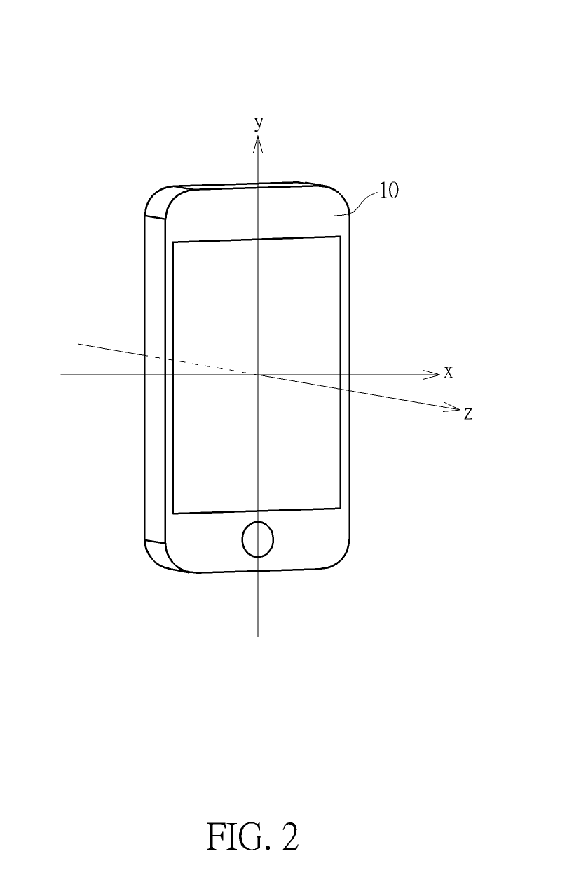

In the electronic device 10, the gyroscope 106 may be utilized for detecting a turning action of the electronic device 10. Please refer to FIG. 2, which is a schematic diagram of the gyroscope 106 detecting motion of the electronic device 10 in different directions. In FIG. 2 the electronic device 10 is illustrated as a mobile phone, but the electronic device 10 may be any device having voice communication functionalities. The gyroscope 106 may predefine the directions of the electronic device 10, in order to measure the angular velocity of the electronic device 10 as it turns in different directions. In three-dimensional space, the angular velocity of the electronic device 10 may include three components along three directions: the x-axis, y-axis and z-axis. The angular velocity components along these three directions are components turning around the x-axis, y-axis and z-axis, respectively. The x-axis is a horizontal axis parallel to the front of the electronic device 10, the y-axis is a vertical axis parallel to the front of the electronic device 10, and z-axis is an axis perpendicular to the front of the electronic device 10.

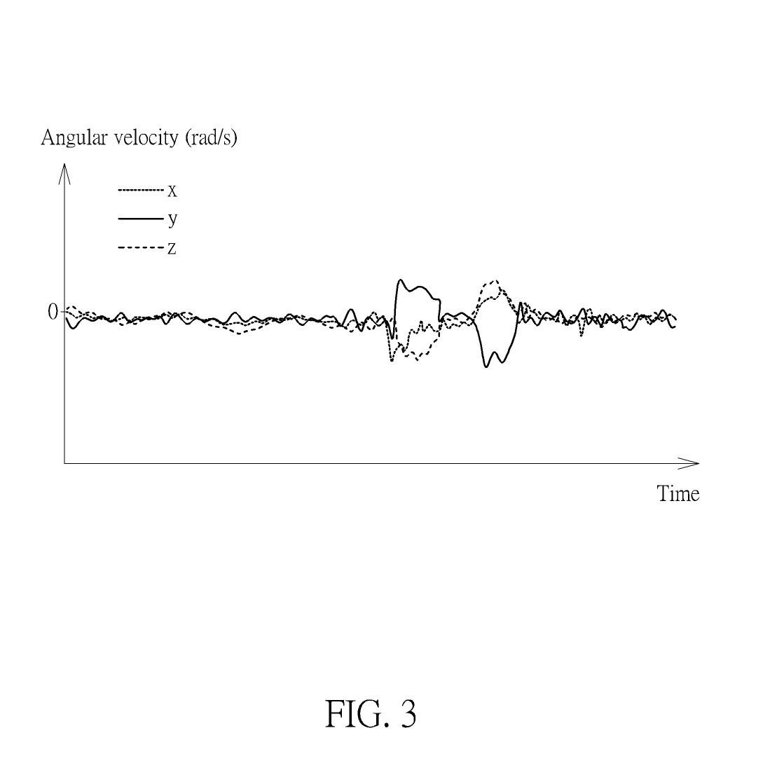

When receiving a phone call, the user may bring the electronic device 10 towards her to see the caller identity. If the user needs to answer the phone call, the user may turn the front of the electronic device 10 towards their left side and use their right ear to listen, or turn the front of the electronic device 10 towards their right side and use their left ear to listen. In such a situation, the gyroscope 106 may detect an evident angular velocity along the y-axis direction of the electronic device 10. In another possible situation, the user may put the electronic device 10 on a table so that the electronic device 10 faces upward. When receiving a phone call, the user may pick up the electronic device 10 if the user desires to answer the phone call, and then listen via their right or left ear. In such a situation, the gyroscope 106 may detect angular velocities along the x-axis, y-axis and z-axis of the electronic device 10. Please refer to FIG. 3, which is a waveform diagram generated by the gyroscope 106 detecting motion of the electronic device 10 in different directions. As shown in FIG. 3, during the process of answering the phone call, the x-axis, y-axis and z-axis directions simultaneously appear as evident angular velocity signals; hence, the angular velocity has components along all directions of the electronic device 10.

In practice, no matter which method is used to answer the phone call, the user is required to turn the front of the electronic device 10 to their left or right side, and the gyroscope 106 thereby detects the angular velocity along the y-axis direction. In a preferable embodiment, a threshold value for the y-axis direction may be predefined. When the gyroscope 106 detects that an angular velocity along the y-axis direction is greater than the threshold value, the action detection module 104 may determine that the turning action in the electronic device 10 has been detected, and accordingly determine whether the user performs the answering action.

In general, the action of picking up a mobile telephone to talk takes about 0.2-1 second, which comprises turning the mobile telephone 90 degrees in the y-axis direction (i.e. the front of the mobile phone turning leftward or rightward). The corresponding angular velocity is substantially between 1.57-7.85 radians per second (rad/s). Preferably, the threshold value for the angular velocity along the y-axis direction may be set to 1.57 rad/s according to the speed of the user picking up the telephone. If the gyroscope 106 detects that the angular velocity along the y-axis direction is greater than 1.57 rad/s, the action detection module 104 may determine that the turning action in the electronic device 10 has been detected, in order to determine whether the user performs the answering action. In other embodiments, the user may arbitrarily set the threshold value for the angular velocity according to her answering habit or the type of electronic device 10. The angular velocities along different directions may also be incorporated or combined with different threshold values for further detection; this is not limited herein.

After the gyroscope 106 detects the turning action in the electronic device 10, the P-sensor 108 further determines whether the approaching action is detected. The P-sensor 108 may detect a distance between the P-sensor 108 and an object in front of it, in order to determine whether there is any object within a specific area in front of the electronic device 10. The P-sensor 108 may predefine a threshold value to 5 centimeters (cm) for determination of the approaching action. Since the approaching action is the action of the user bringing the electronic device 10 to approach her ears, the electronic device 10 may be close to the ears after the approaching action is performed. The P-sensor 108 may detect that the distance between the P-sensor 108 and an object is less than 5 cm to determine that the approaching action is accomplished. When the action detection module 104 detects the turning action and then detects the approaching action, the electronic device 10 may determine that the user needs to answer the phone call and thereby performs the answering action. The voice communication module 102 may therefore activate the voice communication. In such a situation, the user is only required to perform a natural or customary action for answering a phone call without additionally pressing or clicking a confirmation button.

In other embodiments, the user may arbitrarily set the threshold value for the detection distance of the P-sensor 108 according to user habit or type of the electronic device 10. For example, the electronic device 10 may include a mobile phone and earphones. When the user utilizes the earphones for voice communication, the earphones will be brought close to the ears. In such a situation, the P-sensor 108 may be disposed in the earphones to detect the action of the earphones approaching the ears. The threshold value for the detection distance of the P-sensor 108 may be set to a smaller value, e.g. 0.5 cm. A biological sensor may also be incorporated to perform the detection, in order to ensure that the voice communication is only activated under the condition of the earphones approaching the ears, rather than the voice communication being activated when the earphones are put on a table or stowed in a backpack. In another embodiment, the mobile phone itself and the earphones thereof may both include a proximity sensor.

Please note that the present invention may activate the voice communication according to characteristics of the natural actions of people answering a mobile phone. Those skilled in the art can make modifications and alternations accordingly. The proximity sensor is only an exemplary embodiment for detecting an object in front of the electronic device. In other embodiments, the distance of the object in front of the electronic device may be measured via a light sensor or other type of sensor. In the above embodiment, the activation of voice communication is determined via detection of the answering action, which consists of the turning action and the approaching action; in other embodiments, the determination of voice communication may also be incorporated with other customary actions of the user to enhance the determination accuracy. For example, before performing the answering action, the user may first look at the call display message on the electronic device 10, and the P-sensor 108 may thereby detect that the distance between the electronic device 10 and an object in front of it is greater than 5 cm for a certain period of time. The P-sensor 108 may detect whether the electronic device 10 approaches any object (e.g. detect whether the distance between the electronic device 10 and the object in front of it is greater than 5 cm) before the action detection module 104 starts to perform detection. The detection of the answering action is only started when no object approaches the front of the electronic device 10, in order to avoid the voice communication being activated when the electronic device 10 is flipped in a pocket or backpack. The abovementioned threshold value for the P-sensor 108 to determine the distance between the electronic device 10 and the object in front of it may also be arbitrarily adjusted according to user requirements.

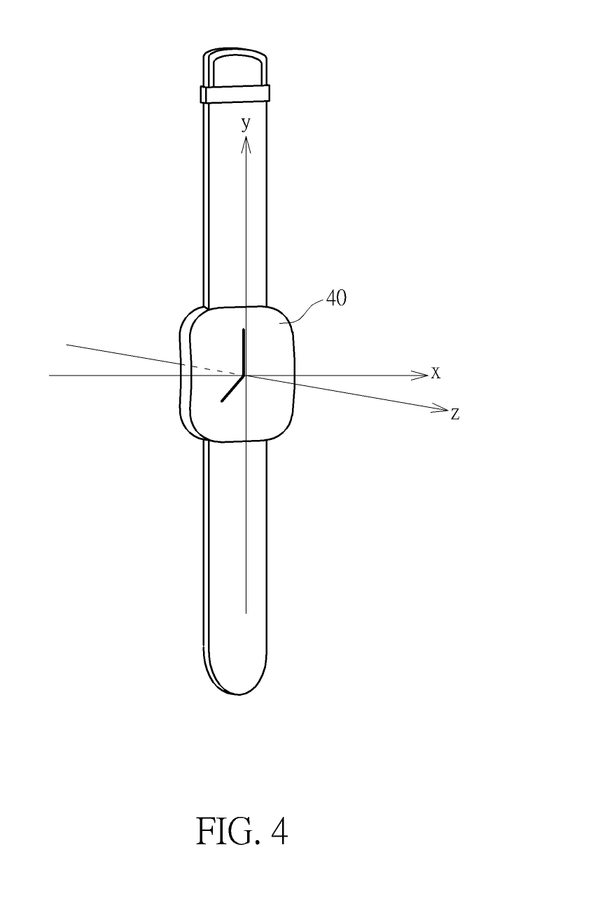

In the above embodiment, the electronic device 10 utilizes a mobile phone to perform call display and voice communication processing, but in other embodiments, the electronic device 10 may also include other types of devices. Refer to FIG. 4, which is a schematic diagram of a smart watch 40 according to an embodiment of the present invention. The smart watch 40 may be a slave device of the electronic device 10 for performing call display. In this embodiment, the user may use the smart watch 40 to look at call display messages or receive phone call notifications, and then use the mobile phone or earphones to answer.

The smart watch 40 may be equipped with a gyroscope for performing detection of the turning action. For the smart watch 40, the surface may be regarded as the front, where the x-axis may be a horizontal axis parallel to the front of the smart watch 40, the y-axis may be a vertical axis parallel to the front of the smart watch 40, and the z-axis may be an axis perpendicular to the front of the smart watch 40. The angular velocity of the smart watch 40 may be divided into three components along the x-axis, y-axis and z-axis. The user may wear the smart watch 40 on her hand. When the user receives a phone call, the customary actions of the user may include turning their arm to turn the watch surface towards her in order to see the caller identity. This turning action may generate a more evident component along the x-axis direction of the smart watch 40. In a preferable embodiment, a threshold value for the x-axis direction may be predefined. When the gyroscope 106 detects that an angular velocity along the x-axis direction is greater than the threshold value, the action detection module 104 may detect the turning action, and accordingly determine whether the user performs the answering action.

If the user utilizes the earphones to perform the voice communication, the P-sensor may be utilized for measuring whether the earphones approach the user's ears. If the user directly utilizes the mobile phone to perform the voice communication, the gyroscope equipped in the mobile phone may be incorporated with the P-sensor to measure the answering action of the user, e.g. the turning action and the approaching action. The operations related to using the earphones or the mobile phone to perform the voice communication are illustrated above, and will not be narrated herein. In addition, the smart watch 40 may also be equipped with a P-sensor to assist in the detection of the answering action. For example, when the user looks at the call display message on the smart watch 40, the P-sensor may detect that the distance between the smart watch 40 and an object in front of it is greater than 5 cm for a certain period of time. The P-sensor may detect whether the smart watch 40 approaches any object (e.g. detect whether the distance between the smart watch 40 and the object in front of it is greater than 5 cm) before the action detection module starts to detect the answering action. The detection is started when no object approaches the front of the electronic device 10, in order to avoid the voice communication being activated when the electronic device 10 is flipped in a pocket or backpack.

In an embodiment, the action of customarily hanging up the phone may be utilized for terminating the voice communication. If the electronic device 10 is a mobile phone, the user may perform a removing action when hanging up the phone, by moving the mobile phone away from her ears. The user then turns the front of the mobile phone towards her. Under several conditions, however, the purpose of the user performing the above action is to input data to the mobile phone or look at a message rather than hanging up the phone. In a preferable embodiment, another specific gesture or turning action may be utilized for determining whether to terminate the voice communication. For example, the voice communication module 102 may terminate the voice communication when the action detection module 104 detects that the user takes the mobile phone and performs an inward turning action.

When the voice communication ends, the user may first take the electronic device 10 away from her ears; hence, the P-sensor 108 may detect that the distance between the electronic device 10 and an object in front of it increases (e.g. the distance varies from less than 5 cm to more than 5 cm), which means that the user performs the removing action. The gyroscope 106 then detects whether the user performs an inward turning action. The voice communication module 102 may terminate the voice communication when the inward turning action is detected. As a result, the user may not need to additionally press or click a voice communication termination button, and the electronic device 10 may automatically terminate the voice communication.

In an embodiment, the user may switch between different voice communication devices. For example, the electronic device 10 may include a mobile phone and earphones. When receiving a phone call, the user may first utilize the mobile phone to perform the voice communication, and then switch to earphones after a period of time. In this embodiment, the mobile phone and the earphones may both include an action detection module for detecting different answering actions in different voice communication modes. When the user utilizes the mobile phone to perform the voice communication, the action detection module inside the earphones may detect whether the user utilizes the earphones to perform the answering action; in this case, the proximity sensor may detect whether the user wears the earphones. When the proximity sensor detects that the user wears the earphones, the action detection module inside the mobile phone may detect whether the user performs the removing action on the mobile phone; in this case, the proximity sensor may detect whether the mobile phone moves away from the user's ears, and the gyroscope then detects whether the angular velocity of the mobile phone is greater than a threshold value. When the removing action is detected, the voice communication module 102 may transfer the voice communication from the mobile device itself to the earphones. When receiving a phone call, the electronic device 10 may also determine which voice communication device the user wishes to utilize according to the information detected by the action detection modules in each voice communication device.

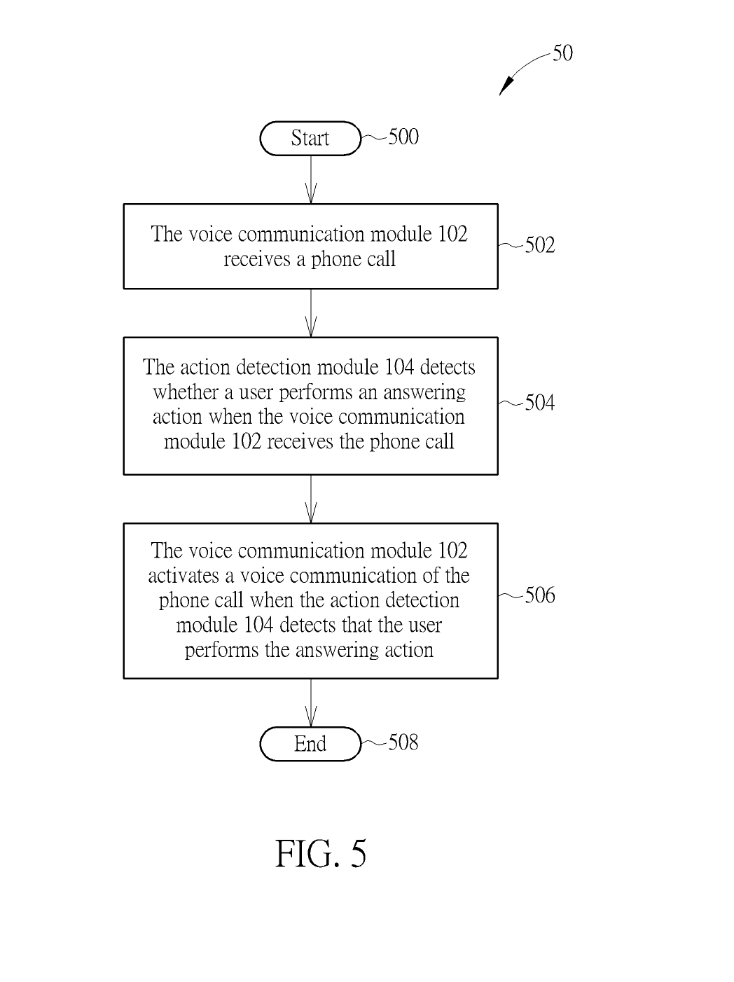

The abovementioned operations of the electronic device 10 may be summarized into a phone call answering process 50, as shown in FIG. 5. The phone call answering process 50 includes the following steps:

Step 500: Start.

Step 502: The voice communication module 102 receives a phone call.

Step 504: The action detection module 104 detects whether a user performs an answering action when the voice communication module 102 receives the phone call.

Step 506: The voice communication module 102 activates a voice communication of the phone call when the action detection module 104 detects that the user performs the answering action.

Step 508: End.

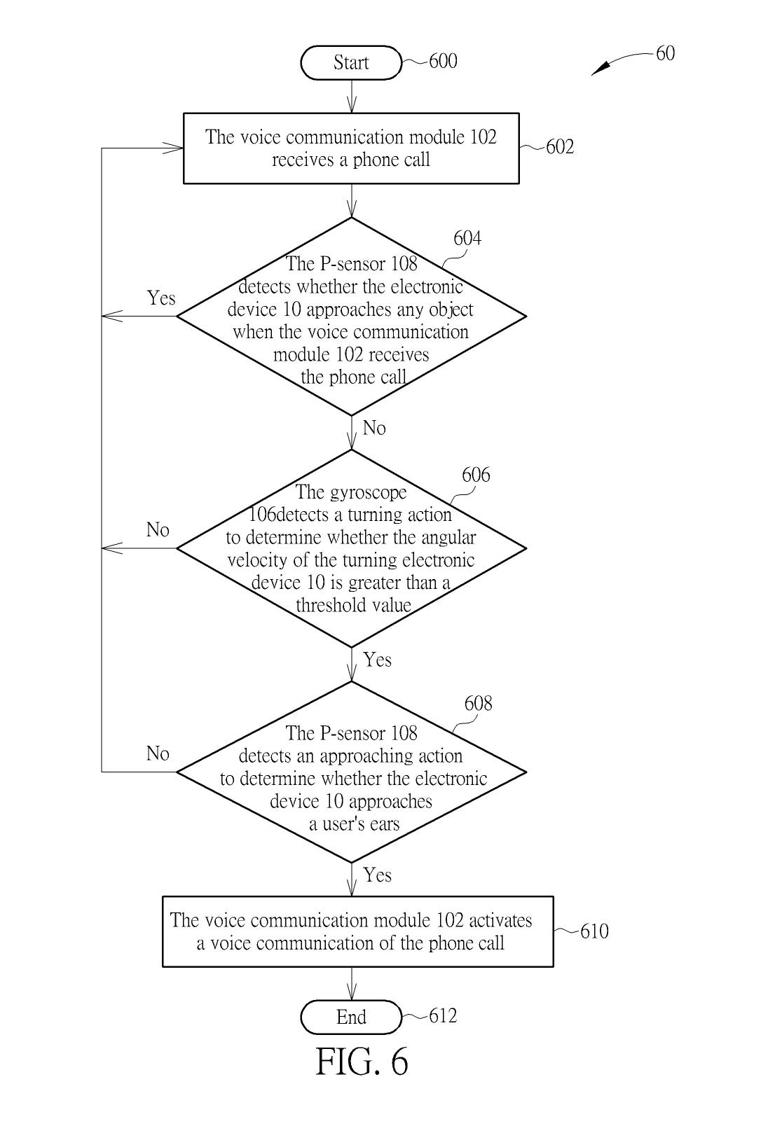

In the phone call answering process 50, the detection of the answering action is performed via a combination of detection of the turning action and the approaching action; hence, detailed operations of the electronic device 10 may further be summarized into another more detailed phone call answering process 60, as shown in FIG. 6. The phone call answering process 60 includes the following steps:

Step 600: Start.

Step 602: The voice communication module 102 receives a phone call.

Step 604: The P-sensor 108 detects whether the electronic device 10 approaches any object when the voice communication module 102 receives the phone call. If yes, go to Step 600; otherwise, go to Step 606.

Step 606: The gyroscope 106 detects a turning action to determine whether the angular velocity of the turning electronic device 10 is greater than a threshold value. If yes, go to Step 608; otherwise, go to Step 600.

Step 608: The P-sensor 108 detects an approaching action to determine whether the electronic device 10 approaches a user's ears. If yes, go to Step 610; otherwise, go to Step 600.

Step 610: The voice communication module 102 activates a voice communication of the phone call.

Step 612: End.

The detailed operations of the phone call answering processes 50 and 60 can be known by referring to the above description. Modifications thereof can be made by those skilled in the art after reading the above description.

In the prior art, the most frequently used voice communication functionality of a smart phone requires the user to press a physical button or a confirmation button on a touch screen in order to receive a phone call. In comparison, the present invention may separate a natural action of the user answering a phone call into a turning action and an approaching action, and respectively perform the detection in order to determine whether the user wishes to answer the phone call. When the user receives a phone call notification, the user only needs to perform the natural or customary action of answering the phone call without pressing a confirmation button, leading to the electronic device automatically activating the voice communication.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A voice communication method for an electronic device comprising:
receiving a phone call;
detecting whether a user performs an answering action when receiving the phone call; and
activating a voice communication of the phone call when detecting that the user performs the answering action;
wherein the answering action does not comprise an action of triggering a button on the electronic device.

2. The voice communication method of claim 1, wherein the step of detecting whether the user performs the answering action when receiving the phone call comprises:
detecting a turning action of the user comprising the user turning the electronic device; and
detecting an approaching action of the user comprising the user taking the electronic device to approach their ears.

3. The voice communication method of claim 2, wherein the turning action appears in the electronic device during reception of the phone call, and the method further comprises:
detecting whether an angular velocity of the electronic device in a direction is greater than a threshold value, and the electronic device performs the answering action when the angular velocity in the direction is greater than the threshold value.

4. The voice communication method of claim 1, wherein the electronic device further comprises a slave device for performing a call display, and the voice communication method further comprises:
detecting whether the slave device approaches any object before detecting the answering action when receiving the phone call; and
detecting a turning action of the user comprising the user turning the slave device.

5. The voice communication method of claim 4, wherein the slave device comprises a smart watch.

6. The voice communication method of claim 1, wherein the electronic device further comprises earphones for performing the voice communication, and the voice communication method further comprises:
detecting an approaching action of the user comprising the user taking the earphones to approach their ears.

7. The voice communication method of claim 1, further comprising:
detecting whether the user performs a removing action when the user performs the voice communication;
detecting whether the user performs an inward turning action when the removing action is detected; and
terminating the voice communication when the inward turning action is detected.

8. The voice communication method of claim 1, wherein the electronic device comprises a first voice communication device and a second voice communication device, and the voice communication method further comprises:
detecting whether the user performs a first answering action on the second voice communication device when the user utilizes the first voice communication device to perform the voice communication;
detecting whether the user performs a removing action on the first voice communication device when the first answering action is detected; and
switching the voice communication from the first voice communication device to the second voice communication device when the removing action is detected.

9. An electronic device, comprising:
a voice communication module, for receiving a phone call; and
an action detection module, for detecting whether a user performs an answering action when the voice communication module receives the phone call;
wherein the voice communication module activates a voice communication of the phone call when the action detection module detects that the user performs the answering action; and
wherein the answering action does not comprise an action of triggering a button on the electronic device.

10. The electronic device of claim 9, wherein the answering action comprises:
a turning action of the user comprising the user turning the electronic device; and
an approaching action of the user comprising the user taking the electronic device to approach their ears.

11. The electronic device of claim 10, wherein the action detection module comprises:
a gyroscope, for detecting the turning action; and
a proximity sensor, for detecting the approaching action.

12. The electronic device of claim 11, wherein the turning action appears in the electronic device when the voice communication module receives the phone call, the gyroscope detects whether an angular velocity of the electronic device in a direction is greater than a threshold value, and the electronic device performs the answering action when the angular velocity in the direction is greater than the threshold value.

13. The electronic device of claim 9, wherein the electronic device further comprises:
a slave device, for performing a call display;
wherein the action detection module further detects whether the slave device approaches any object before detecting the answering action when the voice communication module receives the phone call; and
wherein the action detection module detects a turning action of the user comprising the user turning the slave device.

14. The electronic device of claim 13, wherein the slave device comprises a smart watch.

15. The electronic device of claim 9, further comprising:
earphones, for performing the voice communication;
wherein the action detection module further detects an approaching action of the user comprising the user taking the earphones to approach their ears.

16. The electronic device of claim 9, wherein the action detection module further detects whether the user performs a removing action when the user performs the voice communication, and detects whether the user performs an inward turning action when the removing action is detected.

17. The electronic device of claim 16, wherein the voice communication module terminates the voice communication when the inward turning action is detected by the action detection module.

18. The electronic device of claim 9, wherein the electronic device comprises a first voice communication device and a second voice communication device, and the action detection module further detects whether the user performs a first answering action on the second voice communication device when the user utilizes the first voice communication device to perform the voice communication, and detects whether the user performs a removing action on the first voice communication device when the first answering action is detected.

19. The electronic device of claim 18, wherein the voice communication module switches the voice communication from the first voice communication device to the second voice communication device when the removing action is detected by the action detection module.
